(19) United States
(12) Patent Application Publication
(10) Pub. No.: US 2024/0403723 A1
(43) Pub. Date: Dec. 5, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yuta HATAKEYAMA, Tokyo (JP); Yuzuru OKAJIMA, Tokyo (JP)

(73) Assignee: NEC Corporation, Minato-ku, Tokyo (JP)

(21) Appl. No.: 18/700,382

(22) PCT Filed: Oct. 22, 2021
(86) PCT No.: PCT/JP2021/039076

§ 371 Date: Apr. 11, 2024

(51) Int. Cl. G06N 20/10

(52) U.S. Cl. CPC G06N 20/10

(57) ABSTRACT

In an information processing device, an input means acquires each actual case formed by features. An artificial case generation means generates a plurality of artificial cases based on each acquired actual case. An artificial case selection means configured to select each artificial case in which a prediction of a machine learning model is to be uncertain, from the plurality of artificial cases. After that, an output means outputs each selected artificial case.

### TECHNICAL FIELD

The present disclosure relates to a creation of training cases for use in machine learning.

### BACKGROUND ART

In a case where the number of training cases used for machine learning is not sufficient, artificially generated cases (hereinafter referred to as “artificial cases”) may be used as training cases. For example, Non-Patent Document 1 discloses a technique for generating the artificial cases similar to actual cases close to a decision boundary. Non-Patent Documents 2 and 3 disclose a generation method of the artificial cases.

### PRECEDING TECHNICAL REFERENCES

### Patent Document

Non-patent document1: Ertekin (2013). Adaptive oversampling for imbalanced data classification. In Information Sciences and Systems 2013-Proceedings of the 28th International Symposium on Computer and Information Sciences (ISCIS), pp. 261-269.
Non-Patent Document 2: Bucilua, C., Caruana, R. and Niculescu-Mizil, A.: Model Compression, Proc. ACM SIGKDD, pp. 535-541. (2006).
Non-Patent Document 3: Chawla, N. V., Bowyer, K. W., Hall, L. O., and Kegelmeyer, W. P.: SMOTE: Synthetic minority over-sampling technique, Journal of Artificial Intelligent Research, 16, 321-357. (2002).

### SUMMARY

### Problem to be Solved by the Invention

However, in the above technique, generated artificial cases do not necessarily contribute to improving a predictive performance of a machine learning model.

It is one object of the present disclosure to provide an information processing device capable of generating the artificial cases which contribute to improving a prediction performance of the machine learning model.

### Means for Solving the Problem

According to an example aspect of the present disclosure, there is provided an information processing device including:
an input means configured to acquire each actual case formed by features;
an artificial case generation means configured to generate a plurality of artificial cases based on each acquired actual case;
an artificial case selection means configured to select each artificial case in which a prediction of a machine learning model is to be uncertain, from the plurality of artificial cases; and
an output means configured to output each selected artificial case.

According to another example aspect of the present disclosure, there is provided an information processing method including:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.

According to still another example aspect of the present disclosure, there is provided a recording medium storing a program, the program causing a computer to perform a process including:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.

### Effect of the Invention

According to the present disclosure, it is possible to generate artificial cases which contribute to improving a prediction performance of a machine learning model.

### BRIEF DESCRIPTION OF THE DRAWINGS

FIG. 1A and FIG. 1B are diagrams for schematically explaining a basic method for generating artificial cases.

FIG. 2 is a diagram for schematically explaining a method in example embodiments.

FIG. 3A and FIG. 3B are diagrams for explaining an effect of the present embodiment compared with the basic method.

FIG. 4 is a block diagram illustrating a hardware configuration of an artificial case generation device according to a first example embodiment.

FIG. 5 is a block diagram illustrating a functional configuration of the artificial case generation device of the first example embodiment.

FIG. 6 is a diagram for schematically explaining and example of a selection method of an artificial case.

FIG. 7 is a diagram for schematically explaining another example of the selection method of the artificial case.

FIG. 8 is a diagram for schematically explaining a further example of the selection method of the artificial case.

FIG. 9 is a diagram for schematically explaining a Query by committee which is an example of an active learning.

FIG. 10 is a diagram schematically illustrating a method using the active learning to select an actual case.

FIG. 11 is a flowchart of an artificial case generation process.

FIG. 12 is a block diagram illustrating a functional configuration of an information processing device of a second embodiment.

FIG. 13 is a flowchart of a process by the information processing device of a second embodiment.

### EXAMPLE EMBODIMENTS

In the following, example embodiments will be described with reference to the accompanying drawings.

### Explanation of Principle

A principle of a method according to an example embodiment will be described.

### Basic Method

First, an example of a method for creating training cases to be used for machine learning will be described as a basic method. In the machine learning, accuracy of an acquired machine learning model may be improved by adding not only actual cases which have been observed but also artificial cases made to resemble the actual cases to the training cases. However, even if artificial cases are added at random, it is difficult to efficiently improve the accuracy of the machine learning model. Therefore, in the basic method, the actual cases in which prediction of the machine learning model is uncertain, that is, the actual cases in which the prediction is difficult are selected, and a plurality of artificial cases similar to that actual cases are generated and added to the training cases. By repeating this process, the training cases are increased and prediction accuracy of the machine learning model is improved.

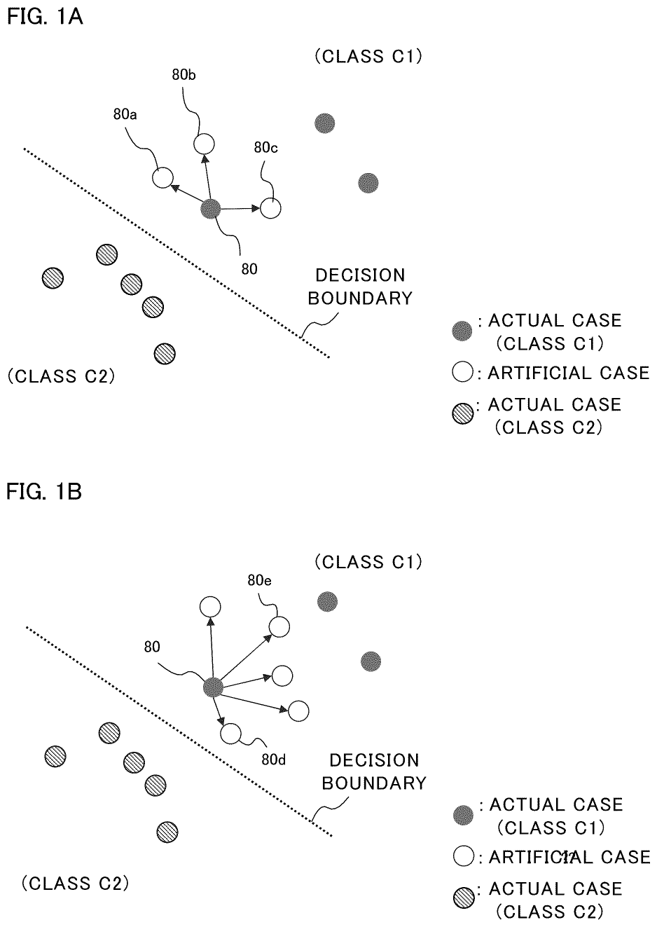

FIG. 1A is a diagram schematically illustrating the basic method. Now assume that a support vector machine (SVM) is used as the machine learning model to perform two-class classification. FIG. 1A is a diagram in which cases are arranged in a feature space. As depicted, the actual cases are classified into classes C1 and C2 using a decision boundary. Here, each actual case close to the decision boundary in the feature space is considered as a case in which the prediction is uncertain.

The basic method first obtains the actual cases close to a decision space, and generates a predetermined number of the artificial cases (v artificial cases) similar to the acquired actual cases. In an example of FIG. 1A, an actual case 80 close to the decision boundary is acquired as the actual case in which the prediction is uncertain, and artificial cases 80a to 80c similar to the actual case 80 are generated. The artificial cases are generated by synthesizing the actual cases in which the prediction is uncertain and other actual cases close to those the actual cases. For instance, each artificial case may be generated using the following formula.

$$[ Math 1 ]$$

$${\hat{x}}_{v} = λ {x}_{i} + ( 1 - λ ) {x}_{j} \\ {\hat{x}}_{v} : Generated artificial case \\ {x}_{i} : Actual case near boundary of SVM \\ {x}_{j} : Actual case in vicinity of {x}_{i} \\ 0 \leq λ \leq 1 is balance parameter \qquad ( 1 )$$

Next, the basic method then reconstructs SVM by adding v generated artificial cases to the training cases. After that, the basic method acquires actual cases in which the prediction is uncertain based on a reconstructed SVM, and generates the artificial cases similar to the acquired actual cases. The basic method outputs the generated artificial cases after this process is repeated for a certain number of times.

### Issues of Basic Method

However, the artificial case obtained by the above basic method does not always improve the prediction accuracy of the machine learning model. This is because the basic method mainly has the following two problems.

A first problem is that the artificial case generated from an uncertain actual case is not necessarily similarly uncertain. FIG. 1B illustrates an example of generating an artificial case using the basic method. In the example of FIG. 1B, the actual case 80 close to the decision boundary is adopted as an actual case in which prediction is uncertain, and five artificial cases similar to this actual case 80 have been generated. Of these, it is considered that the artificial case 80d is close to the decision boundary and corresponds to the uncertain case as well as the actual case 80. However, the artificial case 80e and the like are far from the decision boundary in the feature space, and are not necessarily to be the uncertain case. Such artificial cases do not contribute to improve a prediction performance of the machine learning model.

A second problem is that it becomes redundant in a case where a plurality of artificial cases generated from the same actual cases are used as the training cases. Since the v artificial cases generated from the same actual cases by the basic method are similar to each other, the larger the number v of artificial cases, the more similar artificial cases are added to the training cases, and the less contribution to improve the prediction performance. In addition, there is a possibility that a distribution of the training cases deviates from a distribution of original actual cases and adversely affects the prediction accuracy by adding only similar artificial cases. In this regard, the second problem can be suppressed by reducing the number v of artificial cases, but then the first problem described above becomes larger. In other words, in a case where the number v of artificial cases is large, it is more likely that good artificial cases will be added by chance, but if the number v is small, only artificial cases that do not contribute to improve the performance may be added.

### Technique of Example Embodiments

In view of the above problems, a technique of the example embodiment performs the following processes.
(Process 1) Generate a plurality of artificial cases by selecting each actual case in some way.
(Process 2) Select each artificial case in which the prediction is uncertain, from the generated artificial cases, and add the selected artificial case as a training case.

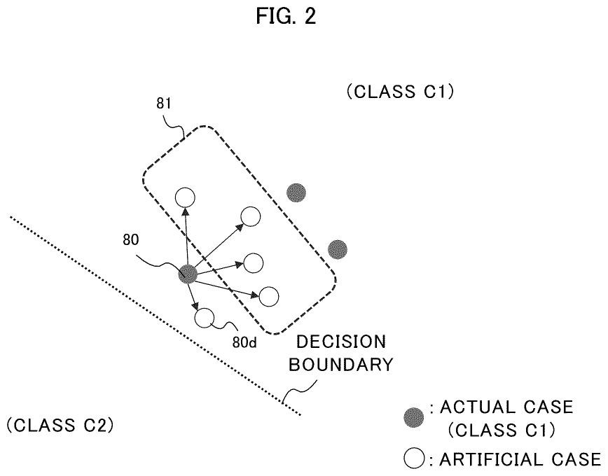

FIG. 2 is a diagram for schematically explaining the technique in the example embodiments. FIG. 2 is a diagram in which an example is arranged in the feature space in the same manner as FIGS. 1A and 1B. In the example of FIG. 2, the method of example embodiments selects the actual case 80 and generates five artificial cases based on the actual case 80. Next, the technique of the example embodiment excludes each artificial case far from the decision boundary (the artificial cases in a rectangle 81) from the five artificial cases generated, and adopts only the artificial case 80d close to the decision boundary. That is, the artificial cases in the rectangle 81 is excluded because the prediction cannot necessarily to be uncertain, and the artificial case 80d close to the decision boundary is adopted as a case in which the prediction is uncertain.

According to this technique, the artificial cases in which the predictions are less uncertain are no longer added to the training cases, so that only artificial cases in which the predictions are actually uncertain are added to the training cases. Thus, the above problem 1 is solved. In addition, by excluding the artificial cases in which the predictions are less uncertain, the above problem 2 is solved, as only similar artificial cases are not added to the training cases. Note that since the artificial cases are generally conducted by synthesis of cases, a cost of generating the artificial cases is low. In contrast, a computational cost of machine learning due to the increased number of training cases is high. Therefore, as in the method of the example embodiment, it is more efficient to create a large amount of artificial cases once and add only good cases to the training cases, because a computational cost of the machine learning is reduced.

### Effect of Example Embodiment

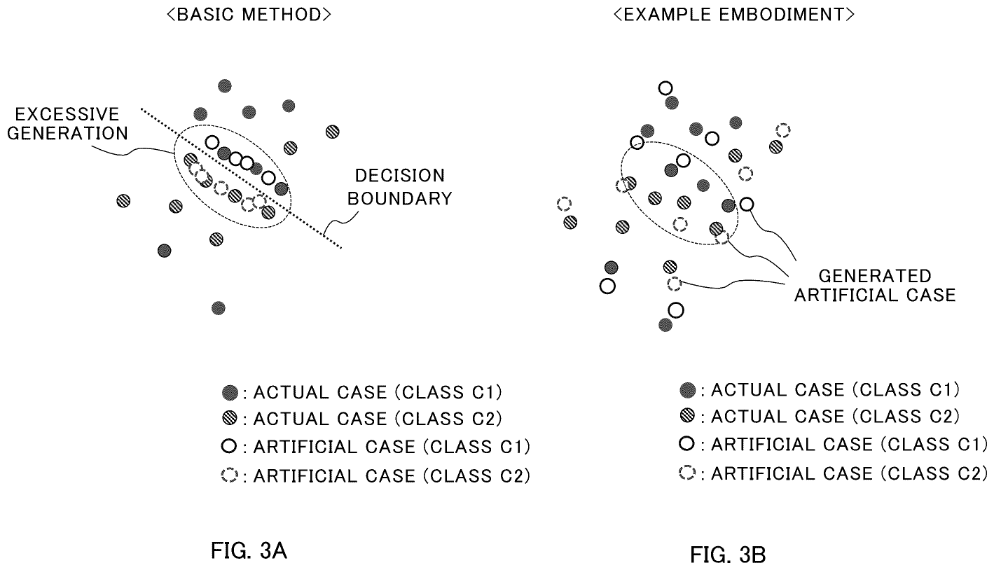

FIG. 3A and FIG. 3B are diagrams for explaining an effect of the present embodiment compared with the basic method. FIG. 3A illustrates cases generated by the basic method, and FIG. 3B illustrates cases generated by the technique in the example embodiments. In the basic method, it is repeated that after the actual cases in which the predictions are uncertain are selected, the plurality of artificial cases are generated from the selected cases. Therefore, in the basic method, the artificial cases tend to be excessively generated in a similar place in the feature space, as depicted in FIG. 3A.

In contrast, since the technique in the example embodiments selects each artificial case in which the prediction is uncertain from the generated artificial cases, it is possible to add each case to the place in which the prediction of the machine learning model is uncertain without excessively generating cases in the similar place in the feature space as depicted in FIG. 3B. Therefore, it is possible to generate artificial cases which improve the prediction accuracy of the model from a small number of actual cases. Moreover, as a result, it is possible to generate the artificial cases which retain a distribution of original actual cases and efficiently improve the prediction accuracy of the model.

### First Example Embodiment

Next, an artificial case generation device 100 according to a first example embodiment will be described. The artificial case generation device 100 generates artificial cases to be added to the training cases based on the actual cases.

### [Hardware Configuration]

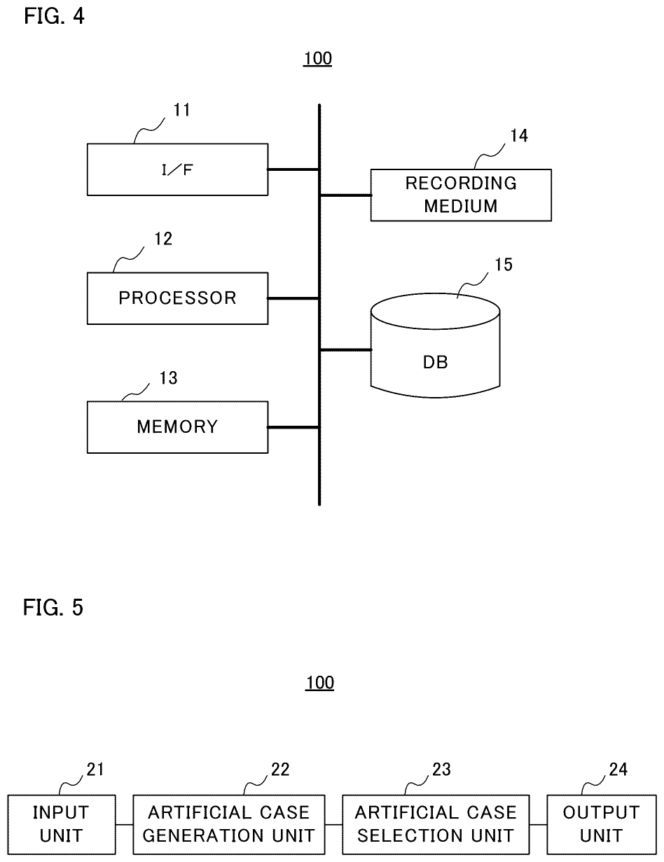

FIG. 4 is a block diagram illustrating a hardware configuration of the artificial case generation device according to the first example embodiment. As depicted, the artificial case generation device 100 includes an interface (I/F) 11, a processor 12, a memory 13, a recording medium 14, and a database (DB) 15.

The interface 11 inputs and outputs data to and from an external device. Specifically, the interface 11 acquires the actual cases from an outside.

The processor 12 is a computer such as a CPU (Central Processing Unit) and controls the entire artificial case generation device 100 by executing programs prepared in advance. The processor 12 may be a GPU (Graphics Processing Unit) or an FPGA (Field-Programmable Gate Array). The processor 12 executes the artificial case generation process to be described later.

The memory 13 consist of a ROM (Read Only Memory) and a RAM (Random Access Memory). The memory 13 is also used as a working memory during various process operations by the processor 12.

The recording medium 14 is a non-volatile and non-transitory recording medium such as a disk-shaped recording medium, a semiconductor memory, or the like, and is configured to be detachable with respect to the artificial case generation device 100. The recording medium 14 records various programs executed by the processor 12. In a case where the artificial case generation device 100 executes various kinds of processes, the program recorded in the recording medium 14 is loaded into the memory 13 and executed by the processor 12. The DB 15 stores the actual cases input through the interface 11 and the artificial cases generated based on the actual cases.

### [Functional Configuration]

FIG. 5 is a block diagram illustrating a functional configuration of the artificial case generation device 100 of the first example embodiment. The artificial case generation device 100 includes an input unit 21, an artificial case generation unit 22, an artificial case selection unit 23, and an output unit 24.

The input unit 21 acquires a plurality of actual cases, and outputs to the artificial case generation unit 22. The artificial case generation unit 22 selects the actual cases in some method from the plurality of actual cases being input. A method for selecting the actual cases will be described later. Then, the artificial case generation unit 22 generates a plurality of artificial cases using the actual cases selected, and outputs the generated artificial cases to the artificial case selection unit 23. Note that, the process performed by the artificial case generation unit 22 corresponds to the process 1 described above.

The artificial case selection unit 23 selects artificial cases in which the predictions are uncertain from the plurality of artificial cases which have been generated, and outputs to the output unit 24. The method for selecting the artificial cases in which the predictions are uncertain will be explained in detail later. Incidentally, a process executed by the artificial case selection unit 23 corresponds to the process 2 described above. Then, the output unit 24 adds the input artificial cases to the training cases to be used for training the machine learning model.

### [Artificial Case Selection Unit]

Next, the artificial case selection unit 23 will be described in detail. The artificial case selection unit 23 selects each artificial case to be added as the training case from the plurality of artificial cases generated by the artificial case generation unit 22.

### (1) Method for Selecting Artificial Cases

First, a method for selecting artificial cases by the artificial case selection unit 23 will be described.

### Method 1

In a method 1, the artificial case selection unit 23 selects each “artificial case in which the prediction is uncertain” as described with reference to FIG. 2. For instance, among the plurality of artificial cases, the artificial case selection unit 23 selects each artificial case closest to the decision boundary, or each artificial case within a predetermined distance from the decision boundary.

### Method 2

In a method 2, instead of simply selecting each artificial case in which the prediction is uncertain, the artificial case selection unit 23 selects “a plurality of artificial cases in which the predictions are uncertain and are not similar to each other”. By this selection, since non-similar artificial cases are added without selecting similar redundant artificial cases and the artificial cases not similar to each other are added, it is possible to improve the efficiency of learning, and the problem 2 described above is further successfully solved. In detail, as the method 2, any of the following three methods are used.

### Method 2-1

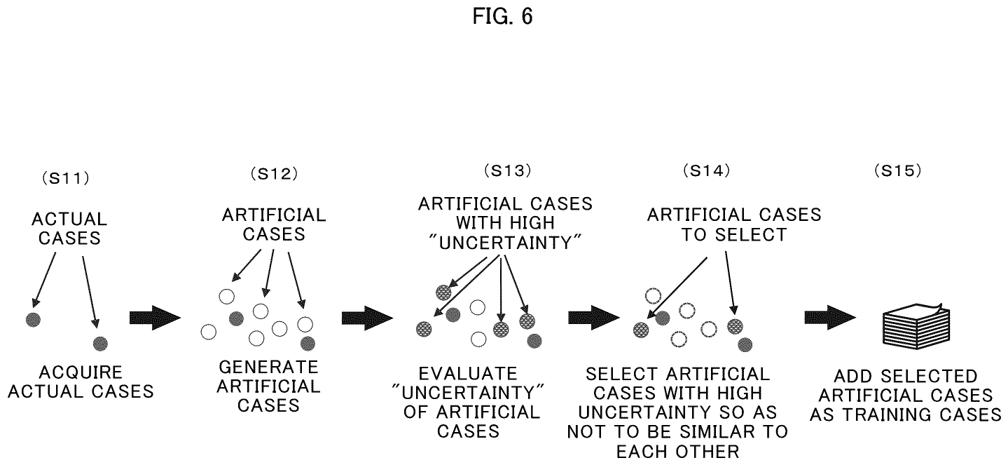

In a method 2-1, the artificial case selection unit 23 calculates a degree of similarity between the artificial cases, and selects the artificial case so as not to be similar to each other. FIG. 6 is a diagram schematically illustrating the method 2-1. First, in step S11, the input unit 21 acquires a plurality of actual cases. Next, in step S12, the artificial case generation unit 22 generates a plurality of artificial cases from each actual case. Next, in step S13, the artificial case selection unit 23 calculates the uncertainty of each prediction for the plurality of artificial cases being generated, and selects each artificial case in which the prediction is uncertain, that is, the artificial case in which the uncertainty is high.

Next, in step S14, the artificial case selection unit 23 selects the artificial cases with higher uncertainty from the plurality of artificial cases in which the predictions are uncertain so as not to be similar to each other. Specifically, the artificial case selection unit 23 calculates the degree of similarity between the artificial cases, and does not select an artificial case having a high degree of similarity to the artificial case which has been already selected. Thus, the artificial cases which are not similar to each other are selected. After that, in step S15, the output unit 24 adds the selected artificial case to the training cases.

### Method 2-2

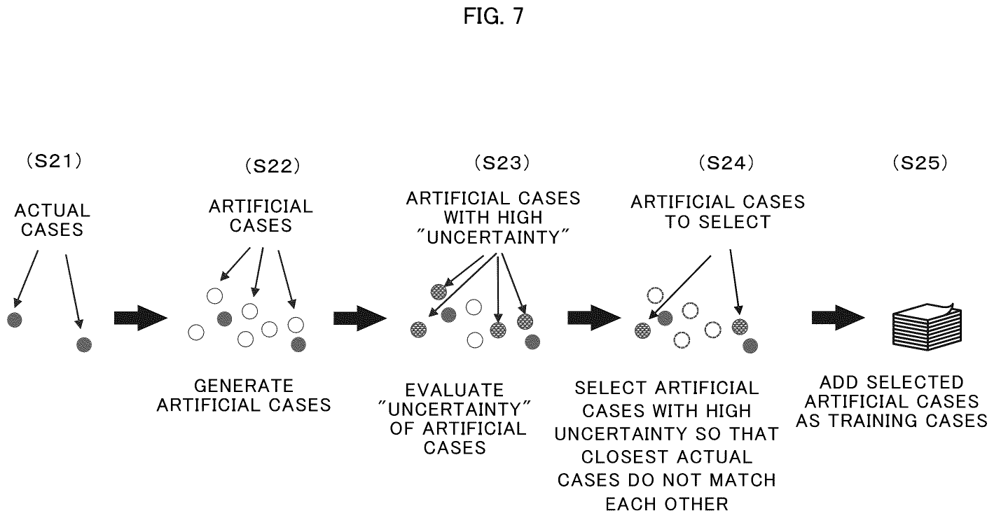

In a method 2-2, the artificial case selection unit 23 selects each artificial case so that the actual cases closest to the artificial case to be acquired do not match each other. FIG. 7 is a diagram schematically illustrating the method 2-2. First, in step S21, the input unit 21 acquires a plurality of actual cases. Next, in step S22, the artificial case generation unit 22 generates a plurality of artificial cases from each actual case. Next, in step S23, the artificial case selection unit 23 calculates the uncertainty of the prediction for the generated plurality of artificial cases, and selects the artificial cases in which the predictions are uncertain, that is, the artificial cases having a high uncertainty.

Next, in step S24, the artificial case selection unit 23 selects the artificial cases in which the predictions are uncertain, from a plurality of artificial cases in which the prediction is uncertain so that actual cases with the closest distance do not match. Specifically, the artificial case selection unit 23 determines each actual case in which a distance in the feature space is closer to each of the artificial cases having the high uncertainty (hereinafter, referred to as “closer neighbor actual case”), and selects a plurality of artificial cases so that the closer neighbor actual cases are different from each other. For instance, the artificial case selection unit 23 selects the artificial case one by one from the plurality of artificial cases having the same actual case as the closer neighbor actual case. Thus, artificial cases that are not similar to each other are selected. After that, in step S25, the outputting unit 24 adds the selected artificial cases to the training cases.

In this case, as the distance of the artificial case and the actual case, the artificial case selection unit 23 may use a Euclidean distance, may use a distance other than the Euclidean distance, or may use a similarity such as a cosine similarity.

Moreover, instead of selecting the artificial case so that the closer neighbor actual cases do not match as described above, the artificial case selection unit 23 may select artificial cases so that a predetermined number of neighbor cases (M neighbor cases, where M≤ K) are not match each other, from among a predetermined number of neighbor cases (K neighbor cases) having closer distances.

### Method 2-3

In a method 2-3, the artificial case selection unit 23 selects each artificial case not to match the actual cases being generation sources. Specifically, in response to generation of a plurality of artificial cases from actual cases by the artificial case generation unit 22, the artificial case selection unit 23 pairs the actual cases to be the generation sources with each artificial case. Next, the artificial case selection unit 23 calculates the uncertainty for each artificial case, and acquires one or more artificial cases in an order of high uncertainty. At this time, the artificial case selection unit 23 does not acquire the artificial case which is paired with the actual case being the same as that for another artificial case already acquired, that is, does not acquire the artificial case where the same actual case as the artificial case already acquired is the generation source. As a result, a plurality of artificial cases with the same actual case being the generation source are no longer selected at the same time. Thus, the artificial case selection unit 23 acquires a certain number of artificial cases. After that, the output unit 24 adds each selected artificial case to the training cases.

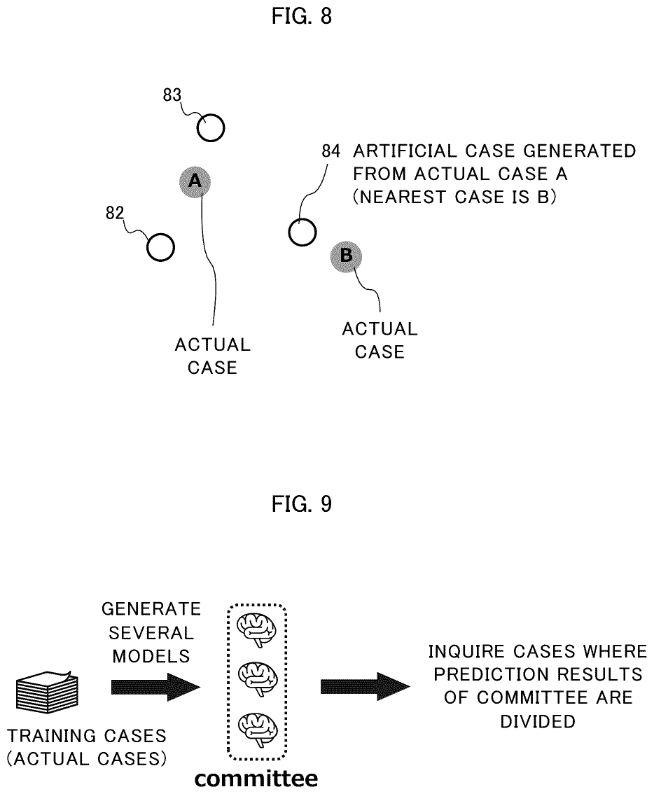

FIG. 8 is a diagram schematically illustrating the method 2-3. As depicted, suppose that there are an actual case A and an actual case B, and three artificial cases 82 to 84 are generated from the actual case A. The artificial case 84 is closer to the actual case B than the actual case A. Therefore, in a case of applying the method 2-2, the artificial case 83 closest to the actual case A and the artificial case 84 closest to the actual case B are selected. In contrast, in method 2-3, the artificial case 84 is closer to the actual case B than the actual case A, but since the actual case A is used as the generation source, the artificial case 84 is paired with the actual case A. Therefore, among the artificial cases 82 to 84 using the actual case A as the generation source, the one with the highest uncertainty is selected.

(2) Method for Selecting Cases with Uncertain Predictions

Next, a method for selecting cases with uncertain predictions will be described. In the present example embodiment, an active learning is utilized as an index to select cases in which the predictions are uncertain. The active learning (active learning) is a technique to find cases which cannot be predicted well by a current machine learning model, and to have an Oracle assign labels. The accuracy of the machine learning model can be improved by relearning by adding cases in which the Oracle has assigned labels. Note that the Oracle may be a human or a machine learning model.

In the present example embodiment, the artificial case selection unit 23 selects an artificial case in which prediction is determined to be uncertain when evaluated by a criterion used in the active learning as an artificial case in which prediction is uncertain. In other words, the artificial case selection unit 23 selects each artificial case subject to query to the Oracle (hereinafter, also referred to as a “query case”) in a case of the evaluation by the technique of the active learning, as the artificial case in which the prediction is uncertain. Hereinafter, each specific technique of the active learning will be described in detail. Note that a technique of the active learning other than the following three techniques may be used.

### (Query by Committee)

A query by committee can be used as the technique of the active learning. FIG. 9 is a schematic explanatory diagram of the Query by committee. The query by committee generates multiple models from the training cases. Note that each type of models may be different. A committee is formed by multiple models, and a prediction result for each model with respect to the training cases is obtained. Moreover, a case where the predictions by the multiple models belonging to the committee are divided is regarded as the query case.

For instance, in a case of using a vote entropy which is one of Query by committee methods, a vote entropy value can be used to determine the query case. In the vote entropy, a case in which an entropy of voting results by a plurality of classifiers is maximum (that is, the case in which the vote is the most split) is regarded as the query case. In detail, a case x\hat{ } assigned by the following equation is the query case. Note that in the present specification, for convenience, a letter where “\hat{ }” is added above a letter “x” is described as a letter “x\hat{ }”.

$$[ Math 2 ]$$

$$\hat{x} = {arg max}_{x} {\underbrace{( - {\sum }_{y} \frac{V ( y )}{C} log \frac{V ( y )}{C} )}}_{VOTE ENTROPY VALUE} \\ C : NUMBER OF CLASSIFIERS \\ V ( y ) : NUMBER OF CLASSIFIERS \\ WHICH PREDICTS LABEL Y \qquad ( 2 )$$

The vote entropy value is indicated in parentheses in a formula (2). Therefore, in a case of using the vote entropy, the artificial case selection unit 23 may regard each artificial case which vote entropy value is a certain value or higher as the artificial case in which the prediction is uncertain.

### (Uncertainty Sampling)

As another method for the active learning, Uncertainty sampling can be used. Specifically, a Least confident in the Uncertainty sampling can be used as an indicator of uncertainty of the prediction. In this case, as depicted in the following equation, the case x\hat{ } where a probability of “a label with a maximum probability” is minimum is regarded as the query case.

$$[ Math 3 ]$$

$$\hat{x} = {arg min}_{x} {\underbrace{( {max}_{y} P ( y \vert x ) )}}_{V 1} \qquad ( 3 )$$

Therefore, in a case of using the Least confident, the artificial case selection unit 23 may consider the case x\hat{ } in which a value V1 in parentheses in an equation (3) is less than a certain value, as the artificial case in which the prediction is uncertain.

Also, Margin sampling in the Uncertainty sampling can be used as the indicator of uncertainty of the prediction. In this case, as expressed in the following equation, the case x\hat{ } in which a difference between a probability of a “first probability label” and a probability of a “second most likely label” is minimum is regarded as the query case.

$$[ Math 4 ]$$

$$\hat{x} = {arg min}_{x} {\underbrace{( P ( {y}_{1} \vert x ) - P ( {y}_{2} \vert x ) )}}_{V 2} \qquad ( 4 )$$

Therefore, in a case of using the Margin sampling, the artificial case selection unit 23 may consider the case x\hat{ } in which a value V2 in parentheses in an equation (4) is less than a certain value, as the artificial case in which the prediction is uncertain.

### [Artificial Case Generation Unit]

Next, the artificial case generation unit 22 will be described in detail.

### (1) How to Select the Actual Case

First, a method for selecting the actual case which is a source of the artificial case will be described. The artificial case generation unit 22 may basically select the actual case in some way. Accordingly, for instance, the artificial case generation unit 22 may generate the artificial case using all actual cases, and may generate the artificial case using an actual case randomly selected from all actual cases.

However, since the artificial case selection unit 23 selects the artificial case in which the prediction is uncertain among the generated artificial cases as the artificial case to be added to the training cases, it is desirable that the actual case serving as the generation source of the artificial case is an actual case in which the artificial case in which the prediction is uncertain is likely to be generated. From this point of view, the active learning described in advance can be also used to select each actual case. That is, the artificial case generation unit 22 selects each actual case in which the prediction is uncertain using the method of the active learning, from a plurality of actual cases, and generates the plurality of artificial cases using the selected actual case.

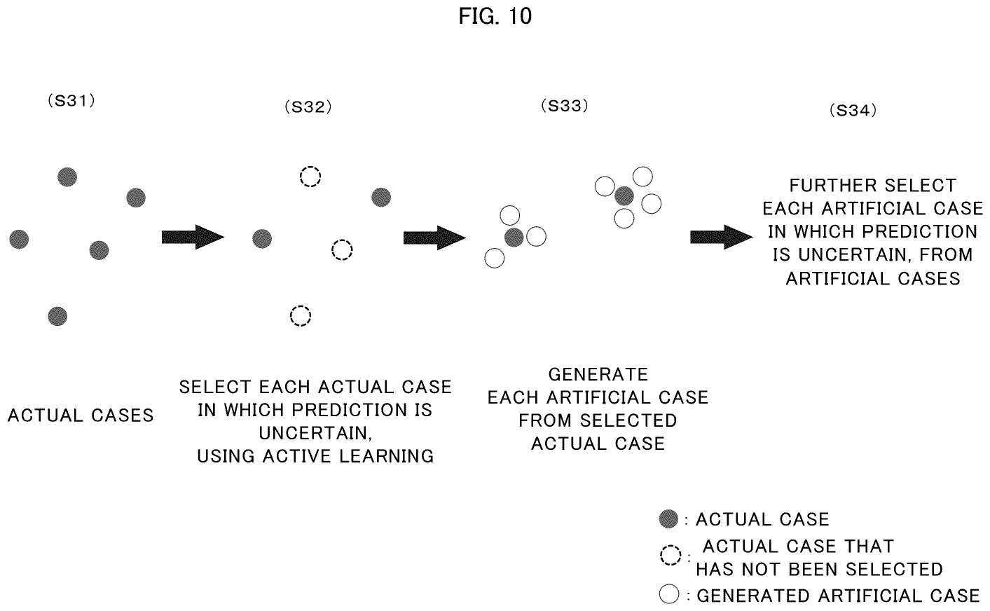

FIG. 10 schematically illustrates a method of using the active learning for the selection of actual cases. First, in step S31, the input unit 21 acquires a plurality of actual cases. Next, in step S32, the artificial case generation unit 22 selects each actual case in which the prediction is uncertain by the active learning. At this time, a method in which the artificial case generation unit 22 selects each actual case in which the prediction is uncertain from the plurality of actual cases is basically similar to a method in which the artificial case selection unit 23 described above selects each artificial case in which the prediction is uncertain from a plurality of artificial cases. That is, the artificial case generation unit 22 selects each actual case in which the prediction is uncertain by using any of the active learning methods described above. As a result, as depicted in FIG. 10, some of the actual cases may not be selected as the generation sources for the artificial cases.

Next, in step S33, the artificial case generation unit 22 generates each artificial case from the selected actual case. Each artificial cases generated is output to the artificial case selection unit 23. Next, in step S34, the artificial case selection unit 23 selects each artificial case in which the prediction is uncertain, from the input artificial case. In this case, an active learning method is used for two times when the artificial case generation unit 22 selects each actual case and when the artificial case selection unit 23 selects the artificial case in which the prediction is uncertain.

### (2) Generation Method of Artificial Case

Next, a generation method of each artificial case by the artificial case generation unit 22 will be described. The artificial case generation unit 22 generates the artificial case by synthesizing the actual case serving as the generation source and another actual case. In one method, the artificial case generation unit 22 can generate each artificial case using the equation (1) described above. Moreover, the artificial case generation unit 22 can also use an artificial case generation technique such as a MUNGE depicted in Non-Patent Document 2 or a SMOTE depicted in Non-Patent Document 3.

### [Artificial Case Generation Process]

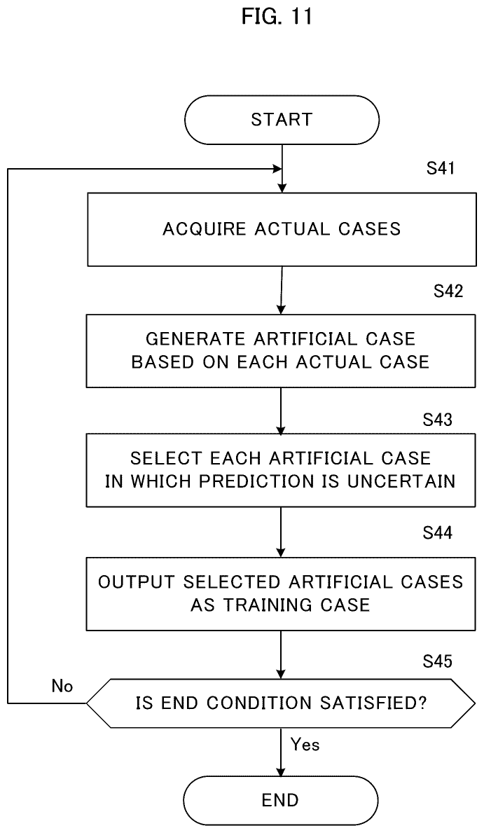

Next, an artificial case generation process by the artificial case generation device 100 will be described. FIG. 11 illustrates a flowchart of the artificial case generation process. This process is realized by the processor 12 depicted in FIG. 4 executing a program prepared in advance and operating as each element depicted in FIG. 5.

First, the input unit 21 acquires the actual case (step S41). Next, the artificial case generation unit 22 generates each artificial case based on the acquired actual case (step S42). At this time, as the actual cases of the generation sources of the artificial cases as described above, the artificial case generation unit 22 may use all actual cases, may use the actual case randomly selected, or may use the actual cases in which the predictions are uncertain and which are selected by the technique of the active learning. In addition, the artificial case generation unit 22 may use the equation (1) as a generation method of the artificial case, and may use a technique such as a MUNGE or a SMOTE. The artificial case generation unit 22 outputs the generated artificial case to the artificial case selection unit 23.

Next, from the entered artificial case, the artificial case selection unit 23 selects each artificial case in which the prediction is uncertain (step S43). At this time, the artificial case selection unit 23 selects the artificial case by any of the methods of the method 1, the method 2-1, the method 2-2, and the method 2-3 as described above. The artificial case selection unit 23 outputs each selected artificial case to the output unit 24. Next, the output unit 24 outputs the input artificial case, that is, the artificial case selected by the artificial case selection unit 23 as the training cases (step S44).

Next, the artificial case generation device 100 determines whether or not an end condition is satisfied (step S45). For instance, when a necessary predetermined number of artificial cases are obtained, the artificial case generation device 100 determines that the end condition is satisfied. When the end condition is not satisfied (step S45: No), the process returns to step S41, and steps S41 to S45 are repeated. On the other hand, when the end condition is satisfied (step S45: Yes), the process is terminated.

### [Assigning Labels to Artificial Cases]

In the example embodiment above described, the artificial case generation device 100 outputs each artificial case without a label, but instead, may output the artificial case with the label. For instance, the output unit 24 may assign the label with respect to each artificial case input from the artificial case selection unit 23, and may output a labeled artificial case. In this case, the output unit 24 may assign the same label as that for the actual case which has been the generation source, with respect to the input artificial case. Alternatively, the output unit 24 may assign a label, which has been prepared in advances and is assigned by the machine learning model, with respect to the input artificial case. Note that the label may be manually assigned to the artificial case and may be output as the labeled artificial case.

### Second Example Embodiment

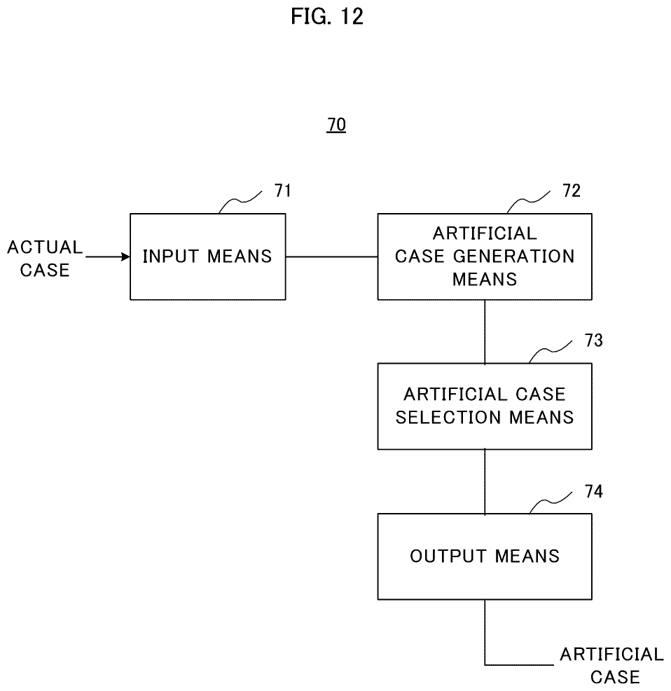

FIG. 12 is a block diagram illustrating a functional configuration of an information processing device according to a second example embodiment. An information processing device 70 includes an input means 71, an artificial case generation means 72, an artificial case selection means 73, and an output means 74.

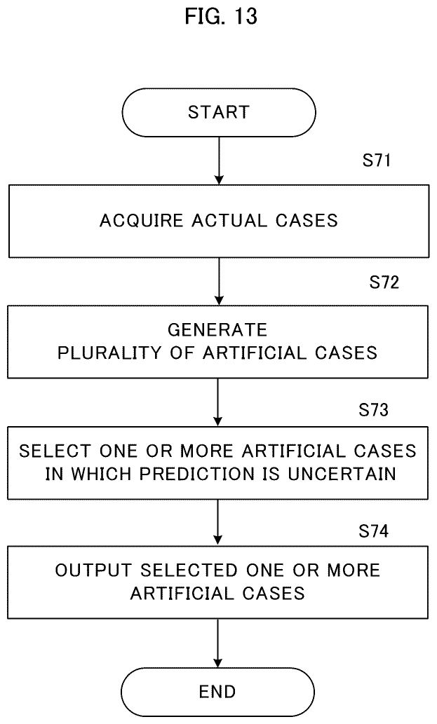

FIG. 13 illustrates a flowchart of a process performed by the information processing device 70 according to the second example embodiment. First, the input means 71 acquires each actual case formed by features (step S71). Next, the artificial case generation means 72 generates a plurality of artificial cases from each actual case (step S72). Next, the artificial case selection means 73 selects each artificial case in which the prediction of the machine learning model is to be uncertain from the generated plurality of artificial cases (step S73). After that, the output means 74 outputs each artificial case selected (step S74).

According to the information processing device 70 of the second example embodiment, it becomes possible to generate each artificial case which contributes to improve the prediction performance of the machine learning model.

A part or all of the example embodiments described above may also be described as the following supplementary notes, but not limited thereto.

### Supplementary Note 1

An information processing device comprising:
an input means configured to acquire each actual case formed by features;
an artificial case generation means configured to generate a plurality of artificial cases based on each acquired actual case;

an artificial case selection means configured to select each artificial case in which a prediction of a machine learning model is to be uncertain, from the plurality of artificial cases; and an output means configured to output each selected artificial case.

### Supplementary Note 2

The information processing device according to supplementary note 1, wherein the artificial case selection means selects the plurality of artificial cases so that each selected artificial case is different.

### Supplementary Note 3

The information processing device according to supplementary note 1 or 2, wherein the artificial case selection means selects the plurality of artificial cases so that actual cases existing in a vicinity are different in a feature space.

### Supplementary Note 4

The information processing device according to supplementary note 1 or 2, wherein the artificial case selection means selects the plurality of artificial cases so that actual cases to be generation sources for respective artificial cases are different from each other.

### Supplementary Note 5

The information processing device according to any one of supplementary notes 1 to 4, wherein the artificial case selection means generates the artificial cases using all input actual cases.

### Supplementary Note 6

The information processing device according to any one of supplementary notes 1 to 4, wherein the artificial case generation means generates the artificial cases using a plurality of actual cases randomly selected from among the input actual cases.

### Supplementary Note 7

The information processing device according to any one of supplementary notes 1 to 4, the artificial case generation means selects each actual case in which a prediction of a machine learning model is uncertain among a plurality of the input actual cases, and generates the plurality of artificial cases using each selected actual case.

### Supplementary Note 8

The information processing device according to any one of supplementary notes 1 to 7, wherein the output means assigns a label to each selected artificial case and outputs each labeled actual case.

### Supplementary Note 9

An information processing method comprising:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.

### Supplementary Note 10

A recording medium storing a program, the program causing a computer to perform a process comprising:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

11 Interface
12 Processor
13 Memory
14 Recording medium
15 Database (DB)
21 Input unit
22 Artificial case generation unit
23 Artificial case selection unit
24 Output unit
100 Artificial case generation device

What is claimed is:

1. An information processing device comprising:
at least one memory configured to store instructions; and
at least one processor configured to execute the instructions to:
acquire each actual case formed by features;
generate a plurality of artificial cases based on each acquired actual case;
select each artificial case in which a prediction of a machine learning model is to be uncertain, from the plurality of artificial cases; and
output each selected artificial case.

2. The information processing device according to claim 1, wherein the processor selects the plurality of artificial cases so that each selected artificial case is different.

3. The information processing device according to claim 1, wherein the processor selects the plurality of artificial cases so that actual cases existing in a vicinity are different in a feature space.

4. The information processing device according to claim 1, wherein the processor selects the plurality of artificial cases so that actual cases to be generation sources for respective artificial cases are different from each other.

5. The information processing device according to claim 1, wherein the processor generates the artificial cases using all input actual cases.

6. The information processing device according to claim 1, wherein the processor generates the artificial cases using a plurality of actual cases randomly selected from among the input actual cases.

7. The information processing device according to claim 1, wherein the processor selects each actual case in which a prediction of a machine learning model is uncertain among a plurality of the input actual cases, and generates the plurality of artificial cases using each selected actual case.

8. The information processing device according to claim 1, wherein the processor assigns a label to each selected artificial case and outputs each labeled actual case.

9. An information processing method comprising:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.

10. A non-transitory computer readable recording medium storing a program, the program causing a computer to perform a process comprising:
acquiring each actual case formed by features;
generating a plurality of artificial cases based on each acquired actual case;
selecting each artificial case in which a prediction of a machine learning model is to be uncertain, from the plurality of artificial cases; and
outputting each selected artificial case.
